(19) United States
(12) Patent Application Publication
(10) Pub. No.: US 2005/0002845 A1
(43) Pub. Date: Jan. 6, 2005

(54) Method of forming phosphoric acid from phosphate ore

(76) Inventors: Allan E. Hokanson, Cincinnati, OH (US); Derek Williams, Wilmington, NC (US); Christopher S. Williams, Wilmington, NC (US)

Correspondence Address: COATS & BENNETT, PLLC, P O BOX 5, RALEIGH, NC, 27602, US

(21) Appl. No.: 10/894,297

(22) Filed: Jul. 19, 2004

Related U.S. Application Data
(63) Continuation-in-part of application No. 10/315,842, filed on Dec. 10, 2002.

(51) Int. Cl. C01B 25/16

(52) U.S. Cl. 423/318

(57) ABSTRACT

The process disclosed herein involves the high temperature processing of phosphate ore in a solid state using a ported rotary kiln. Prior to insertion into the kiln, the ore is pulverized and beneficiated to remove excessive quantities of unwanted materials such as clay, silica, iron, sodium, potassium, and alumina. The calcium oxide to silica ratio of the beneficiated is then adjusted to within a specific acceptable range, a carbon source containing sulfur such as petroleum coke is added and the resulting feed material is pelletized using a binding agent if necessary. The pelletized feed material is then dried, preheated, and fed into a ported rotary kiln. At the elevated temperature maintained in the reducing kiln, tricalcium phosphate undergoes a reduction reaction to produce phosphorus gas and carbon monoxide. Atmospheric air is injected into the rotating kiln chamber, which facilitates the oxidation of phosphorus gas to phosphorus pentoxide and the oxidation of carbon monoxide to carbon dioxide. The reducing kiln exhaust gas stream containing the phosphorus pentoxide and carbon dioxide gas components is processed in an absorption column in which the phosphorus pentoxide is hydrolyzed by water to phosphoric acid. The phosphoric acid is then recovered and concentrated to a commercial grade strength. The slag residue serves as a raw material for cement manufacture.

### CROSS REFERENCE TO RELATED APPLICATION

This is a continuation-in-part of U.S. patent application Ser. No. 10/315,842 filed Dec. 10, 2002 entitled “Method of Forming Phosphoric Acid from Phosphate Ore.” The disclosure within this patent application is expressly incorporated herein by reference.

### FIELD OF THE INVENTION

This invention relates to the processing of phosphate ore for the recovery of phosphoric acid based on solid state processing of the ore at elevated temperatures.

### BACKGROUND OF THE INVENTION

There are three basic methods for preparing phosphoric acid: 1) wet acid, 2) thermal, and 3) reduction.

The wet acid process is the primary method of manufacturing phosphoric acid and is by digestion of phosphate rock with sulfuric acid. Over ninety percent of phosphoric acid production in the U.S., totaling 15 million tones per year, employs this process. This “wet” acid process converts the tri calcium phosphate in apatite ore into phosphoric acid in a series of reactors. The dissolution of the ore by sulfuric acid also produces insoluble calcium sulfate (gypsum), which is removed by filtration and is stockpiled. The filtered acid is concentrated from about 40% to 52% phosphoric acid. The resulting product is known as Merchant Grade.

Purification of Merchant Grade phosphoric acid into Technical Grade is carried out by chemical and solvent extraction. Over the pat forty years, numerous patents have been issued on the use of various organic solvents to extract and purify phosphoric acid into Technical Grade. This digested product contains small amounts of soluble heavy metals and sodium and potassium salts. This solvent extraction process requires one or more extraction columns or a series of countercurrent mixer-settlers. Generally the organic solvent extracts 60 to 75% of the phosphoric acid and the remaining 25 to 40% acid is retained in the raffinate, which is used in the manufacture of fertilizer.

The resultant Technical Grade phosphoric acid does not meet food grade specifications.

In the thermal process, white phosphorus is ignited with air to form gaseous phosphorus pentoxide which is condensed and collected in a hydrator to form phosphoric acid. The white phosphorus is generated by a submerged electric arc furnace reducing apatite ore to form gaseous phosphorus. Gaseous phosphorus passes to a series of water scrubbers where it is condensed and collected. The elemental phosphorus is kept under water to avoid spontaneous combustion in air.

The resultant Thermal Grade acid does meet food grad specifications.

The third process (the reduction method) for producing phosphoric acid is by direct reduction of apatite ore. The ore is formulated with carbon into pellets and fed to a rotary kiln operating at elevated temperatures. In this process gaseous phosphorus pentoxide, exiting with carbon dioxide from the kiln is collected in a hydrator to form phosphoric acid. This process is outlined in the parent application, that is, U.S. patent application Ser. No. 10/315,842 filed Dec. 10, 2002.

The resultant phosphoric acid produced by the reduction process is of higher quality than Technical Grade acid. It can be purified by simple means to meet food grade phosphoric acid.

Food grade acid produced by the Thermal Grade phosphoric acid process is expensive to produce because of the increasingly high cost of electricity to produce elemental phosphorus. Wet acid conversion to food grade involves two processes: solvent extraction, which recovers only about 40%-75% of the acid, and a second purification step to remove dissolved sulfate, sodium and potassium compounds, heavy metals and flooring.

Therefore, there has been and continues to be a need for a process of producing a high quality technical grade acid that can be converted to food and pharmaceutical grade phosphoric acid at a considerable savings in the cost of production. Phosphoric acid produced from the reduction process produces a high quality phosphoric acid which requires simple precipitation of contaminants to meet food grade specification.

### SUMMARY OF THE INVENTION

The present invention entails a method of forming phosphoric acid from phosphate ore by feeding the ore together with carbon source, which contains sulfur or carbon plus sulfur, to a kiln where the mixture is heated to reduce tricalcium phosphate occurring in the ore to a phosphorus gas. The resulting phosphorus gas reacts with oxygen to form phosphorus pentoxide. Thereafter the phosphorus pentoxide is converted to phosphoric acid.

In one method, the carbon source and sulfur are taken from a group comprising coal, coal coke, or petroleum coke. The chosen coke, silica and binder are mixed with the phosphate ore through pulverizing, blending, and moistening to form ore pellets. The pellets are preheated to a temperature of approximately 300 to 500° C. before being directed into a ported rotary kiln. In the kiln, the pellets are heated to a temperature of approximately 1200° C. to 1375° C. for a period of approximately 2 to 4 hours. The heating of the ore pellets results in the production of phosphorus gas, which reacts with oxygen to form phosphorous pentoxide. This gas is then reacted with water in a scrubber to produce phosphoric acid.

In another method, the present invention entails producing phosphoric acid from phosphate ore comprising mixing silica and petroleum coke, coal or other material containing bound sulfur to form a phosphate mixture wherein the petroleum coke or coal includes a high level bound sulfur content. The method further includes reacting the sulfur within the petroleum coke or coal with at least a portion of the phosphate ore mixture to produce phosphorus gas which is ultimately oxidized to form phosphorus pentoxide and converting the phosphorus pentoxide to phosphoric acid.

It is contemplated or hypothesized that the active sulfur or the sulfur that is effective in the reaction, is bound sulfur.

The present invention further entails a method of producing phosphoric acid wherein the CaO/SiO₂ weight ratio is maintained at approximately 0.33-2.2. In one particular method, the CaO/SiO₂ ratio is maintained at 1 and above, and a carbon source, such as petroleum coke or coal, having a high sulfur content is utilized. Here the bound sulfur within the carbon source is reacted with the phosphate ore mixture to produce phosphorus gas, which is ultimately oxidized to form phosphorus pentoxide after which the phosphorus pentoxide is converted to phosphoric acid.

Other objects and advantages of the present invention will become apparent and obvious from a study of the following description and the accompanying drawings, which are merely illustrative of the invention.

### BRIEF DESCRIPTION OF THE DRAWINGS

FIG. 1 is a block diagram illustrating the reduction processing of phosphate ore that leads to the production of phosphoric acid.

FIG. 2 illustrates the impact of various levels of sulfur in converting phosphate ore to phosphoric acid.

### DETAILED DESCRIPTION OF THE INVENTION

The present invention relates to a process for manufacturing phosphorus pentoxide from a phosphate ore and combining or mixing water with the phosphorus pentoxide to form phosphoric acid. Basically, the present invention entails mixing phosphate ore with silica, a carbon source and sulfur to form an ore mixture. The ore mixture, in one embodiment, is pelletized to form the ore mixture into pellets. Thereafter, the pellets may be preheated and then directed into a kiln. Once in the kiln, the ore pellets are heated and, in the course of heating, the phosphorus in the ore is converted to phosphorus gas and then to phosphorus pentoxide. The phosphorus pentoxide is directed from the kiln to an absorber and combined with water to form phosphoric acid. As will be discussed subsequently herein, sulfur in or mixed with the carbon source is effective in increasing the efficiency of phosphorus removal in the present process. More particularly, the sulfur added to the ore, which is usually present in the carbon source, acts as a catalyst.

In the wet acid industry it is desirable to concentrate the phosphate fraction of the ore from about 16% to 30% to minimize the sulfuric acid consumption. In contrast, the present invention eliminates the need for sulfuric acid and makes it possible to use ores with 20% P₂O₅ content thus reducing beneficiation requirements and enabling the use of ore with high magnesium oxide content.

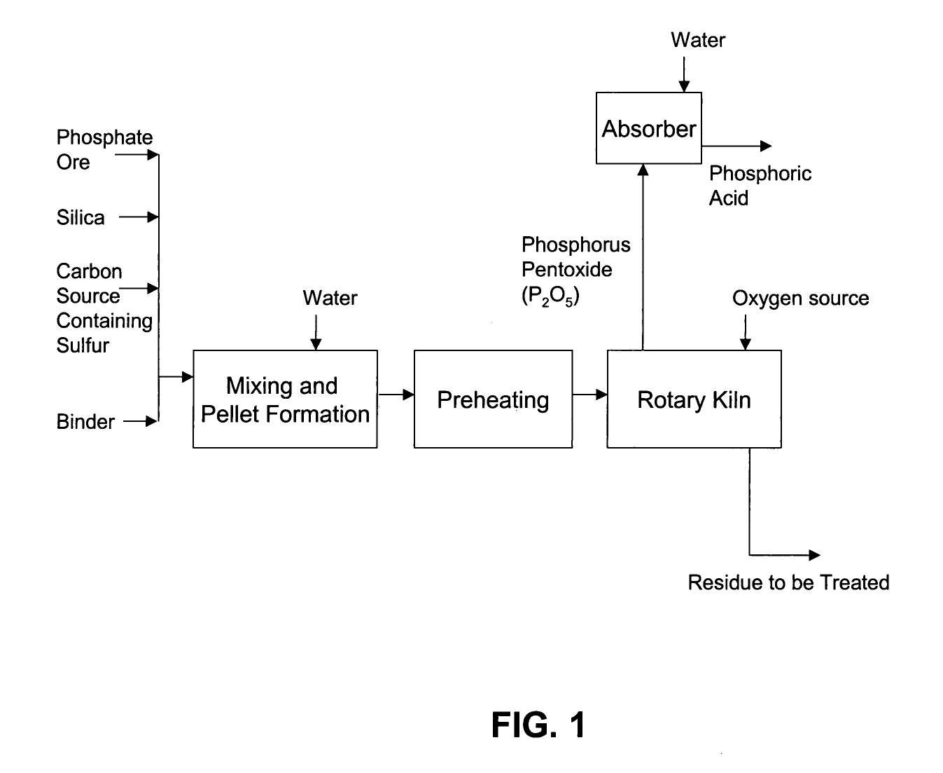

Turning specifically to the process of the present invention, and with reference to FIG. 1, it is seen that, in one embodiment, the phosphate ore is mixed with silica, and a carbon source with sulfur. The bulk of the mixture is the phosphate ore, with sulfur typically comprising approximately 0.5% to 4% of the ore mixture, however an ore mixture comprising greater than 4% sulfur can be used in the present invention. The silica and carbon are initially added to the process, while sulfur can be directed to the process at or before the kiln. In one process, sulfur, contained in the carbon source, is combined with the phosphate ore prior to being directed into the kiln. In most cases, the sulfur would be present in the carbon source mixed with the phosphate ore. However, it should be appreciated that the sulfur could be directed into the kiln where it would react with the tricalcium phosphate in the phosphate ore. In one embodiment of the present invention, it is contemplated that the carbon source will comprise petroleum coke or coal. Low level sulfur petroleum coke will generally consist of between 0% and 3% sulfur, while high level sulfur petroleum coke will generally consist of 3% to 8% sulfur. As used herein, the term low-level sulfur means a sulfur content within petroleum coke, coal, or other carbon source of 0% to 3%. The term high-level sulfur means a sulfur content in petroleum coke, coal, or other carbon source of 3% to 8% of higher. It is hypothesized that the sulfur is more effective in the present process of producing phosphoric acid if the sulfur within the carbon source is what is referred to as bound sulfur. By bound sulfur, it is meant that the sulfur is chemically bound to an element or compound found in the petroleum coke, coal, or other carbon source. The term free sulfur means sulfur found in petroleum coke, coal, or other carbon source that is not chemically bound to another element or compound. However, the phosphoric acid process disclosed herein is not limited to utilizing only bound sulfur. Sulfur that may not be considered bound may also be effective in the present process.

The phosphate ore is pulverized and beneficiated to remove impurities such as clay, iron, sodium, potassium and alumina that are present in the ore prior to mixing with the reactants. In one embodiment, the ore mixture is ground and pressed into pellets using known techniques and methods, such as a bailing drum, a disk pelletizer, or an extruder.

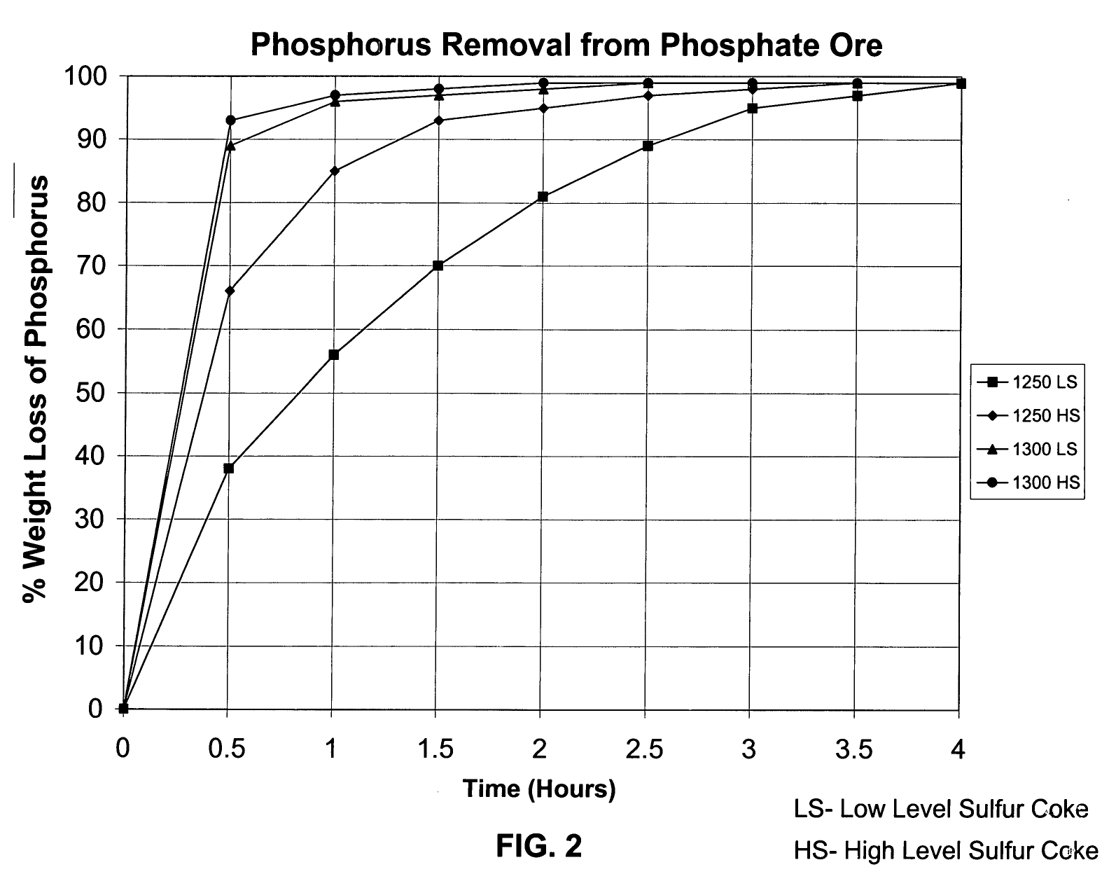

When phosphate ore is mined from the earth, it typically contains, after beneficiation, calcium oxide (CaO), phosphorus pentoxide (P₂O₅), silicon dioxide (SiO₂), magnesium oxide (MgO), aluminum oxide (Al₂O₃), iron oxide (F₂O₃), and other minor constituents. In one embodiment, when silica is mixed with the phosphate ore, the mole ratio of calcium oxide to silica is adjusted to a weight ratio of approximately 0.33 to 2.2 by the addition of silica or sand that maybe recovered from beneficiation. Generally, the recovered sand contains about 90% silica, 6% calcium oxide and 4% phosphorus pentoxide. In mixing the petroleum coke with the phosphate ore, sufficient petroleum coke is added to give a carbon to oxygen mole ratio of approximately 2.4 to 3.0 times the stoichiometeric quantity required to remove oxygen. As will be discussed subsequently herein, petroleum coke containing various sulfur levels ranging from some over 0% to 8% are suitable for the reduction of the phosphate ore. As can be seen from the graph on FIG. 2 the higher the sulfur content in the carbon source the more the efficiency of the removal occurs both in terms of phosphorous extraction and in the reduction of the reaction temperature than experienced in similar processes. In some cases, a binder such as bentonite or lignosulfate can be added to increase pellet strength. Once the ore mixture has been properly adjusted, the resulting pulverized material may be moistened for pelleting or balling. Here approximately 15 parts of water to 100 parts of dry ore mixture maybe used.

After the ore mixture has been pelletized or balled, the material is preheated to about to 300 to 500° C. on a traveling grate or vibrating fluid bed dryer/heater before being directed into a rotary kiln.

After being preheated, the pellets are directed into the kiln, in the case of a preferred embodiment, a ported rotary kiln. The temperature within the kiln is maintained within a temperature range of approximately 1200° to 1375° C. and the pellets are subjected to a residency time of 1.5 hours to 5 hours within the kiln. Various types of kilns may be used. It is contemplated that in a preferred embodiment a ported rotary kiln would be utilized. In such a kiln, the feed material or pelletized ore is placed within a ported-type rotary kiln. Such kilns are well known and appreciated by those skilled in the art and are described in U.S. Pat. Nos. 3,182,980; 3,847,538; 3,945,824; and 4,070,149. The disclosures of these four patents are expressly incorporated herein by reference.

Ported-rotary kilns achieve uniform or near uniform temperature distribution by means of multiple spaced-apart ports in the kiln walls, which allows fuel and air to be fired evenly over and across the length of the kiln bed. It should be noted that uniform temperature distribution is desirable because in cases where there is a non-uniform temperature distribution along the length of a kiln may result in fusing or melting of the ore pellets. However the ported kiln may be used with a single gas burner located at one end of the kiln. In both configurations, inert gas is fed through the ports under the phosphate ore bed. As a third alternative the process can be operated using a kiln that does not have ports and which is fitted with a single gas burner.

As noted above, once placed in the kiln, the ore pellets are subjected to elevated temperatures where the carbon and sulfur within the ore mixture reacts with tricalcium phosphate contained within the pellets through reduction type reactions to form carbon monoxide, sulfur dioxide and phosphorus gas. In the case of a ported-kiln, the ports in the kiln allow air to enter the kiln and effectively oxidize the phosphorus gas and carbon monoxide reaction products. As a result of these oxidation reactions, the phosphorus gas is converted to phosphorus pentoxide (P₂O₅) while the carbon monoxide is converted to carbon dioxide (CO₂). The exothermic heat generated from these two oxidation reactions essentially balances the endothermic heat required for the reduction of the phosphate ore. The same ports which allow air to enter the upper area of the kiln may be utilized to allow inert gas such as nitrogen or nitrogen and carbon dioxide to enter beneath the tumbling bed in order to reduce the partial pressure of the carbon monoxide formed and to provide a boundary layer of inert gas above the pellets to minimize carbon burnout. An embodiment of producing phosphorus pentoxide from phosphate ores by heating the ore in a rotary-type kiln is described by Megy in U.S. Pat. No. 4,351,813 and this patent is expressly incorporated herein.

As a consequence of the reduction reaction and subsequent oxidation reactions described above, the exhaust gas stream leaving the kiln contains primarily carbon dioxide, nitrogen and phosphorus pentoxide. Further, the exhaust gas stream contains a small amount of sulfur dioxide (SO₂) released from the sulfur present in the ore mixture, hydrogen fluoride (HF), and entrained particulate. In order to remove the entrained particulate, which could contaminate the phosphoric acid produced by the present process, a ceramic-lined cyclone collector can be installed in the exhaust gas stream duct to remove substantial portions of the particulate, while a ceramic filter downstream from the cyclone collector may further filter the dust and particulate matter in the exhaust stream.

After particulate matter has been removed from the exhaust gas stream, the exhaust gas stream is quenched with recycled phosphoric acid in a quench chamber located upstream from an absorber to a wet-bulb temperature of about 150° F. before entering the absorber. The phosphorus pentoxide in the exhaust gas stream is converted to phosphoric acid in a conventional fashion such as through a multi-tray absorber. Phosphoric acid leaving the absorber will typically have a concentration range from 50%-60% phosphoric acid. A filter can be utilized to filter solid materials in the phosphoric acid before the phosphoric acid is directed into an evaporator for concentrating the phosphoric acid into a technical grade acid containing a phosphoric acid concentration of 73% or greater.

Further, the sulfur dioxide and hydrogen fluoride gases present in the exhaust gas stream pass from the absorber with the nitrogen and carbon dioxide. In typical processes, the ore may contain about 3% fluorine and in those cases, approximately 10-20% of the fluorine present is released as hydrogen fluoride gas. The gas stream leaving the absorber passes through a lime scrubber in which the lime typically reacts with sulfur dioxide to form calcium sulfate and with the hydrogen fluoride gas to form calcium fluoride.

Spent residue leaving the rotary kiln may be cooled in an inert gas atmosphere to avoid combustion of the excess carbon present. Excess unreacted carbon in the residue is separated from the lime and silica in order to recycle the carbon. The final residue, consisting primarily of lime and silica, may serve as a raw material for various industries such as the cement industry.

### EXAMPLE 1

In one example of the present invention, the material mix contained 68.8% phosphate ore, 7.8% silica, and 23.4% petroleum coke. The phosphate ore as analyzed contained 40.51% CaO, 24.05% P₂O₅, 11.75% SiO₂, 3.5% MgO, and 2.8% Fluorine. The silica contained 98% SiO₂. The petroleum coke had a fixed carbon content of 85.5% and 7% sulfur. The ore mix was grounded to where 75% of the mix passed a 200-mesh screen. These materials were blended with 15 parts of water and extruded in a bench scale extruder into ¼ inch diameter pellets of about 3/8 inch length. The pellets were dried overnight in an oven maintained at 210° F. The dried pellets were placed in a 100 ml crucible and placed in an electric furnace. The following results were obtained and plotted on a graph (see figure No. 2).

| | Time Held at Temp. - | |
|---|---|---|
| Temperature - ° C. | Hours | % Phosphorus Removal |
| 1250 | 2 | 96.6 |
| 1250 | 3 | 98.8 |
| 1300 | 1 | 97.7 |

### EXAMPLE 2

In this test the petroleum coke was reduced to 80% of that used in Example 1. The formulation contained 72.12% phosphate ore, 8.24% silica, and 19.04% petroleum coke contains 7% sulfur. The results were as follows:

| | | | |
|---|---|---|---|
| | | Temperature | |
| Ore | Pet Coke | Time at Temp. | % Phosphate |

| Mesh | Mesh | ° C. | Hours | Removed |
|---|---|---|---|---|
| 200 | 150 | 1250 | 1 | 84.1 |
| 200 | 150 | 1250 | 2 | None Detected |
| 200 | 150 | 1300 | 1 | 96.7 |
| 200 | 150 | 1300 | 2 | None Detected |
| 150 | 150 | 1300 | 1 | None Detected |
| 150 | 150 | 1300 | 2 | None Detected |

These results showed that a coarser grind of ore and reduction of petroleum coke gave similar results. This allows lower use of energy for grinding. A further reduction of petroleum coke resulted in marked reduction of mechanical strength of the pellets together with melting.

### EXAMPLE 3

In a series of laboratory furnace tests, phosphate ore, silica, and petroleum coke were formulated into pellets to determine the effect on efficiently of phosphate reduction at a temperature of 1250° C. and a retention time of 2.5 hours by varying the lime (CaO) to silica (SiO₂) ratio. The ratio was varied over a range of 1.75 to 0.33 of lime to one of silica. Five tests were made to compare the efficiency of petroleum coke containing 7% sulfur as a reducing agent with that of activated carbon having no sulfur. The phosphate ore had the following composition: 37.9% CaO, 24.3% P₂O₅, 18.1% SiO₂, 3.8% MgO, and 3.0% F. The results were as follows;

Percent Phosphorus Removed

| | Petroleum Coke with | Activated Carbon |
|---|---|---|
| Ca/SiO₂ Ratio | 7% Bound Sulfur | No Sulfur |
| 1.75 | 91.3 | 49.2 |
| 1.25 | 88.9 | 84.2 |
| 1.00 | 99.2 | 99.0 |
| 0.75 | 100 | 100 |
| 0.33 | 100 | 100 |

These tests indicate that phosphorus ore reduction becomes more efficient as the silica content in the pellet formulation increases. In other words, the lower the CaO/SiO₂ ratio, the higher the percentage of phosphorus removed. However, low CaO/SiO₂ ratios have some disadvantages. Low CaO/SiO₂ ratios generally result in substantial more feed required and that, in turn, requires increased kiln capacity, all of which increase the cost of the process.

In order to avoid the high cost, it is contemplated that the CaO/SiO₂ weight ratios could be slightly higher, for example, in the range of 1.25 to 1.75. With these CaO/SiO₂ ratios, the tests show the importance of utilizing petroleum coke or some other carbon source with a high level sulfur content. In this case, for example, 91.3% of the phosphorus was removed utilizing petroleum coke with 7% bound sulfur and a CaO/SiO₂ ratio of 1.75. With the same CaO/SiO₂ ratio and the use of activated carbon with no sulfur, only 49.2% of the phosphorus was removed.

As illustrated in FIG. 2, the addition of sulfur increases the efficiency of phosphoric acid production. In particular, as the sulfur levels in the ore mix were increased for a given temperature, there was an increase in the percent weight loss of phosphorus. Moreover, the inclusion of sulfur in the ore mix reduced the time required to reach a certain level of percent weight loss in the ore. In one case, the ore was mixed with a low level of sulfur and heated to 1250° C. (See plot 1250 LS). A desirable percent weight loss level (98%) was reached after 4 hours of heating. In another case, the ore was mixed with a high level of sulfur and also heated to 1250° C. (See plot 1250 HS). Here, the desirable level of percent weight loss was reached after 2.5 hours of heating, thus decreasing the residency time of ore within the kiln. In another case, the ore was mixed with a low level of sulfur and heated to 1300° C. (See plot 1300 LS). A desirable level of percent weight loss was reached after 1.5 hours of heating. Finally, in another case, the ore was mixed with a high level of sulfur and also heated to 1300° C. (See plot 1300 HS). A desirable level of percent weight loss was reached after 1 hour of heating, again demonstrating that higher levels of sulfur within the process decrease the residency time of the ore within the kiln.

Further, the presence of sulfur allows the process to operate at lower temperatures than conventional processes, thus conserving energy and heating time. The melting point of sulfur (444° C.) is surpassed by the temperatures present in the kiln, thus promoting liquefaction of the sulfur present in the ore mix. The liquefaction can take place within the kiln; however, liquefaction of the sulfur in the phosphate ore mixture may take place in a preheating stage prior to entry into the kiln. Here, the liquefaction of sulfur enhances the sulfur's ability to react with the tricalcium phosphate, thus allowing the temperatures within the kiln to be reduced while reaching desired levels of phosphorus gas production. In the embodiment of FIG. 2, sulfur present in the petroleum coke permitted a desirable phosphorus percent weight loss of 98% at a temperature of 1300° C. A preferred temperature range for the extraction of phosphorus within the kiln is 1250° C. to 1375° C., however extraction is possible at temperatures below and above this range. Utilizing higher temperatures within the range allows the phosphorus to be extracted in a shorter duration while achieving desirable percent weight losses.

In addition the process allows use of ore containing high levels of MgO. Since the MgO stays in the solid state, the MgO is left in the solids residue and does not contaminate the phosphoric acid produced. Ores containing 5% MgO and higher have been tested and have shown to have no effect on the production of the phosphoric acid.

The present invention may be carried out in other specific ways than those herein set forth without parting from the spirit and essential characteristics of the invention. The present embodiments are, therefore, to be considered in all respects as illustrative and not restrictive, and all changes coming within the meaning and equivalency range of the appended claims are intended to be embraced therein.

1. A method of producing phosphoric acid from phosphate ore comprising: mixing silica and a carbon source having sulfur with the phosphate ore to form a phosphate mixture; mixing sufficient quantities of the carbon source containing sulfur with the phosphate ore mixture to where the sulfur makes up approximately 0.5 to 4.0 percent of the phosphate mixture by weight; heating the mixture to a temperature of 1200° C.-1375° C.; reacting the sulfur, silica and carbon with the phosphate ore such that the resulting reactions of both carbon and sulfur with the phosphate ore reduces the phosphorous content in the phosphate ore by 95% to form phosphorous gas which is ultimately oxidized to phosphorus pentoxide; and wherein the reduction of the phosphate ore occurs within said temperature range and within a residency time period of two hours or less.

2. The method of claim 1 wherein the sulfur is mixed with the phosphate ore prior to heating.

3. The method of claim 1 wherein the sulfur is contained within the carbon source and bound.

4. The method of claim 1 wherein the phosphate ore mixture is directed into a rotary kiln for heating.

5. The method of claim 1 wherein the carbon source is petroleum coke, and wherein the petroleum coke contains sulfur which makes up approximately 3-12 percent of the petroleum coke.

6. The method of claim 1 wherein the sulfur contained within the petroleum coke is bound sulfur.

7. The method of claim 1 wherein the carbon source is petroleum coke or coal and includes bound sulfur which comprises at least 3% of the petroleum coke or coal.

8. The method of claim 1 wherein the phosphate ore mixture includes a CaO/SiO₂ weight ratio of approximately 0.033 to 2.2.

9. The method of claim 8 wherein the CaO/SiO₂ ratio is approximately 1.0 to 2.2.

10. A method of producing phosphoric acid from phosphate ore comprising: mixing silica and petroleum coke or coal to form a phosphate mixture wherein the petroleum coke or coal includes a high level sulfur content; reacting the sulfur within the petroleum coke or coal with at least a portion of the phosphate ore mixture to produce phosphorous gas which is ultimately oxidized to form phosphorous pentoxide and converting the phosphorous pentoxide to phosphoric acid.

11. The method of claim 10 wherein the sulfur contained within the petroleum coke or coal is bound sulfur.

12. The method of producing phosphoric acid of claim 10 wherein the sulfur comprises approximately 3 to 12 percent of the petroleum coke.

13. The method of claim 11 wherein the sulfur contained within the petroleum coke or coal is bound sulfur.

14. The method of producing phosphoric acid of claim 10 wherein the sulfur found in the petroleum coke comprises approximately 0.5-4.0 percent of the phosphate ore mixture.

15. The method for producing phosphoric acid of claim 10 including liquefying the sulfur to enhance its reaction with the phosphate ore.

16. The method of claim 13 wherein liquefying the sulfur takes place in a preheating step.

17. The method in claim 1 wherein the excess carbon present in the residue is reclaimed and recycled.

18. The method of claim 15 wherein the non-carbon residue is used as a raw material for cement manufacture.

19. A method of producing phosphoric acid from phosphate ore comprising: mixing phosphate ore which includes CaO, SiO₂, and a carbon source to form a phosphate mixture; mixing the phosphate ore and SiO₂ so as to generally maintain a CaO/SiO₂ weight ratio above 1; reacting the phosphate mixture with the carbon source to produce phosphorus gas which is ultimately oxidized to form phosphorus pentoxide and converting the phosphorus pentoxide to phosphoric acid.

20. The method producing phosphoric acid of claim 17 wherein the carbon source is petroleum coke or coal.

21. The method of claim 18 wherein the petroleum coke or coal includes a high level of sulfur.

22. The method of claim 19 wherein the sulfur contained within the petroleum coke or coal is bound sulfur.
